(19) United States
(12) Patent Application Publication
(10) Pub. No.: US 2004/0253976 A1
(43) Pub. Date: Dec. 16, 2004

(54) CONTROLLING A LIGHT SOURCE OF A TELEPHONE KEYPAD

(76) Inventor: Hsien-Chung Lin, Hsin-Chu Hsien (TW)

Correspondence Address: NAIPO (NORTH AMERICA INTERNATIONAL PATENT OFFICE), P.O. BOX 506, MERRIFIELD, VA, 22116, US

(21) Appl. No.: 10/707,059

(22) Filed: Nov. 18, 2003

(30) Foreign Application Priority Data
Jun. 11, 2003 (TW) 092115911

(51) Int. Cl. H04M 1/00

(52) U.S. Cl. 455/550.1

(57) ABSTRACT

The present invention provides a method for controlling light sources of a keypad of a telephone. The telephone includes a plurality of keys and a plurality of light sources installed correspondingly under the plurality of keys. The method includes detecting an operating status of the telephone, and determining all possibly enabled functions and changing at least one part of the light sources from a first status to a second status according to the operating status, in order to show at least one key corresponding to the possibly enabled functions.

### BACKGROUND OF INVENTION

1. Field of the Invention

The present invention relates to a method of controlling a light source of a keypad, and more specifically, to a method of controlling a light source of a telephone keypad.

2. Description of the Prior Art

As wireless communication technology progresses, mobile phones have become indispensable in daily life, and have developed diverse functions in addition to being a telephone. Although the functionality of a mobile phone has expanded, today's mobile phones are smaller and smaller for users” convenience. A present mobile phone only has a keypad as its non-verbal input interface, thus the limited number of keys on the keypad are required to be fully utilized and multifunctional.

There is no standard for size, arrangement, or function of the keys. For instance, a “power” key may be on the right side of one mobile phone and on the left side of a different mobile phone. The same is true of other functional keys. However, the keys on the keypad can be divided into functional keys and number keys. The number keys include ten number keys from “0” to “9” as well as a star (*) key and a pound (#) key, and the functional keys may be of various kinds. Different makers always set up different functional keys for their products, but generally a “power” key, a “dial” key, and arrow keys can be seen in many products. Although the keys are basically the same, since different mobile phones have different functional keys, and each key is actually multifunctional, a similar key may represent different functions in different modes, possibly confusing users. Moreover, an indicative mark is noticeable on each key in general, but it is not very comprehensible due to its small size and variety on meanings.

In order not to confuse users and to enable night use of the mobile phone, most of the mobile phones have light-emitting diodes (LEDs) as light sources under the keypad. Design of the light sources may vary in different mobile phones, but 6-8 LEDs are installed under the keypad in general. When any event is triggered, for example when a key is pressed, someone is calling, an alarm rings, or a message is received, the LEDs installed under the keypad will light up to light up the keys. A user can adjust the brightness of the LED according to his or her own requirement. When the mobile phone is in idle mode, the LEDs are turned off to save power. The light of the LEDs can be seen under daylight and show different colors. There is even a design, set by the user, where the LEDs show different colors according to different callers. Although the LED can show different colors, it is used basically for lighting.

As mentioned above, there are not a great number of keys on a mobile phone, but each key may possess many functions. The keys differ not only in size and arrangement but also in function, confusing users very much. Generally, LEDs are installed under the keypad, but they are used basically for lighting.

### SUMMARY OF INVENTION

It is therefore a primary objective of the present invention to provide a method of controlling a light source of a telephone keypad.

Briefly summarized, the present invention provides a method for controlling a keypad of a telephone. The telephone includes a plurality of keys and a plurality of light sources installed correspondingly under the plurality of keys. The method includes detecting an operating status of the telephone, and determining all possibly enabled functions and changing at least one part of the light sources from a first status to a second status according to the operating status, in order to show at least one key corresponding to possibly enabled functions.

The claimed invention also provides an electronic apparatus including a plurality of keys, each key respectively corresponding to at least one specific function for inputting data, a plurality of light sources installed under the plurality of keys, a status detecting device for detecting an operating status of the electronic apparatus, and an controller for determining all possibly enabled functions and changing the status of at least one part of the light sources according to the operating status in order to show at least one key corresponding to the possibly enabled functions.

These and other objectives of the present invention will no doubt become obvious to those of ordinary skill in the art after reading the following detailed description of the preferred embodiment that is illustrated in the various figures and drawings.

### BRIEF DESCRIPTION OF DRAWINGS

FIG. 1 illustrates a mobile phone according to the present invention.

FIG. 2 illustrates some of the circuitry within the mobile phone of FIG. 1.

FIG. 3 illustrates a status when someone is calling to the mobile phones.

FIG. 4 illustrates a key instruction of the mobile phone.

FIG. 5 illustrates an operation instruction of the mobile phone.

FIG. 6 illustrates a game key instruction of the mobile phone.

FIG. 7 illustrates a data input help of the mobile phone.

FIG. 8 is a flow chart of the present invention.

### DETAILED DESCRIPTION

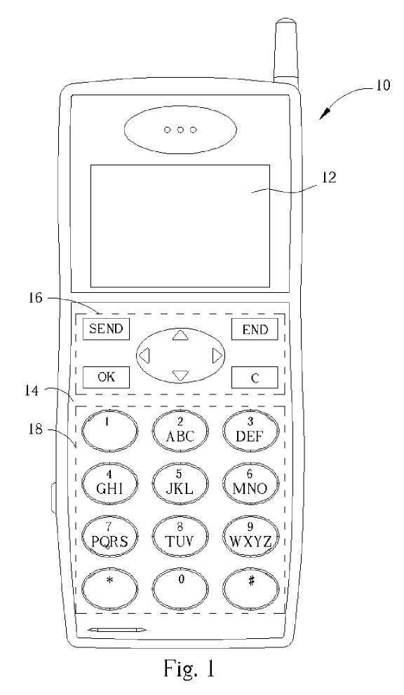

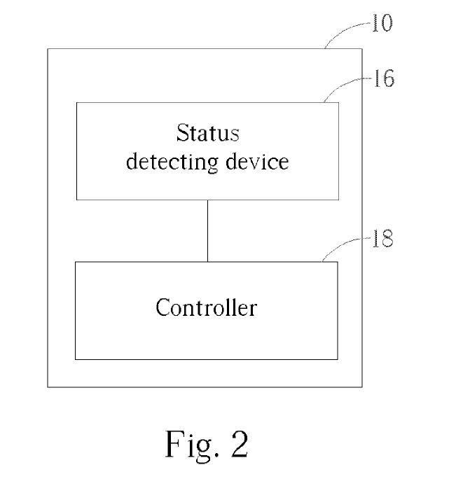

Please refer to FIG. 1 and FIG. 2 showing a mobile phone 10 according to the present invention. The mobile phone 10 includes a status detecting device 16, an controller 18, a liquid crystal display (LCD) panel 12, and a keypad 14. The status detecting device 16 is for detecting the status of the mobile phone 10, the controller 18 is for determining all functions possible to be enabled according to the status of the mobile phone 10 and changing a light source of the keypad 14 accordingly, and the LCD panel 12 is for displaying characters or picture messages.

The keypad 14 includes a functional key set 16 and a number key set 18. The functional key set 16 includes a “send” key, an “end” key, an “OK” key, a “C” (cancel) key, and four arrow keys indicating up, down, left, and right. The number key set 18 includes ten number keys from 0 to 9 as well as a star (*) key and a pound (#) key. Each key of the keypad 14 has an independent light source. As shown in FIG. 1, the functional key set 16 has eight keys and the number key set 18 has twelve, thus the keypad 14 has twenty light sources corresponding to those twenty keys, which means that each key can be lighted up separately. The independent light sources can be LEDs or cold light panels under each key. Since LEDs and cold light panels provide a variety of colors and each key has its own light source, each key can be in different colors and vary light intensity as required. Several embodiments of the present invention are described hereinafter. In the figures representing these embodiments, hash-marked areas represent lighting.

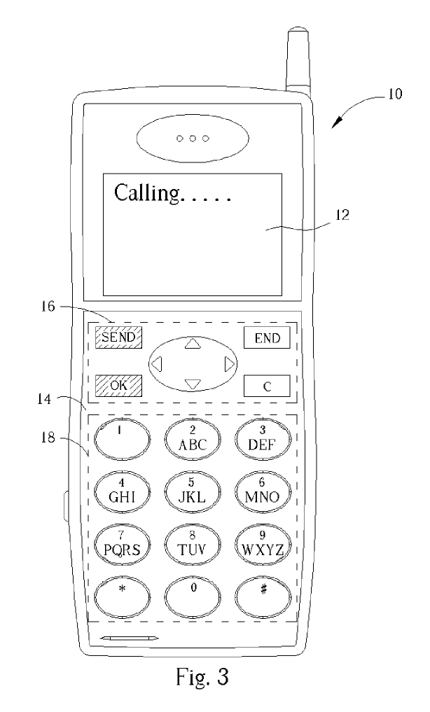

Please refer to FIG. 3 showing when someone is calling to the mobile phone 10. When someone is calling, a user can press the “send” key or the “OK” key of the functional key set 16 to receive the call. However, there is no standard for the arrangement of the functional key set 16 on the mobile phone 10, the “send” key can be on the right side or on the left side of the keypad 14, so that the user may be confused, press incorrect keys and miss important calls. As shown in FIG. 3, while the mobile phone 10 rings, the “send” key and the “OK” key light up to indicate the user to press. In such a manner, even a beginner can know what key to press.

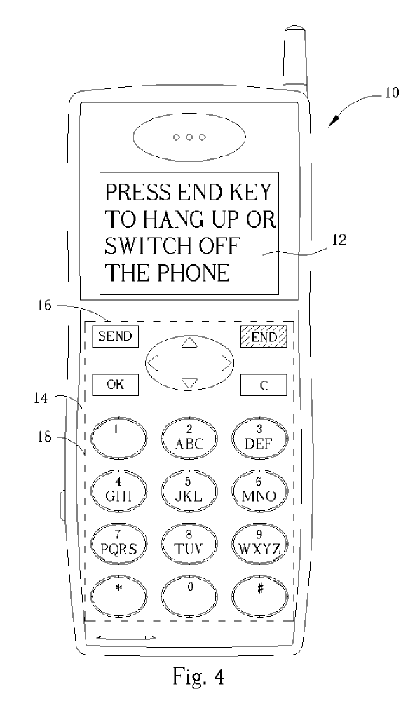

Please refer to FIG. 4 showing a key instruction of the mobile phone 10. As expansion in functionality and reduction in size progresses, every key of the keypad 14 must be fully utilized and multifunctional. Thus, the present invention provides key instructions on the LCD panel 12for each key. By lighting up the key and the key instruction, functions for every key are given. When the key instruction is displayed, the corresponding key starts blinking. As shown in FIG. 4, the instruction for use of the “end” key is displayed on the LCD panel 12 while the “end” key is blinking. The user can press the blinking key to continue reading the instruction, or press another key to end up the instruction.

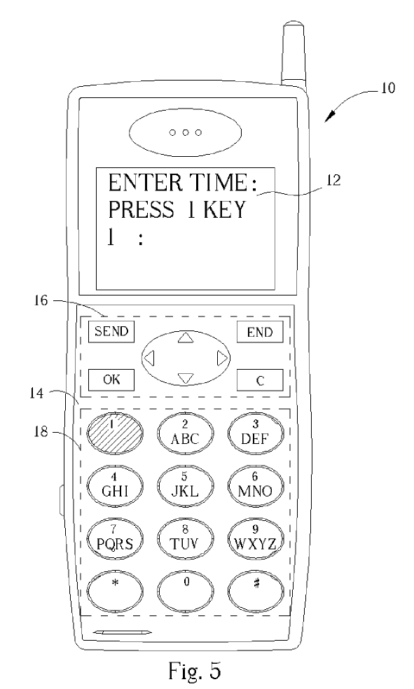

Please refer to FIG. 5 showing an operating instruction of the mobile phone 10. Since the keys of the mobile phone 10 are multifunctional, the user does not always have sufficient time to read the manual of the mobile phone 10, or even if the manual is read, the function may not be completely taught by the illustrations in the manual. The present invention instructs the user directly by lighting up the corresponding keys. Assume that the user does not know how to set up the time, operation instructions can be displayed and the time settings option can be selected. The corresponding keys will blink according to the procedure of the operation, and the user is only required to press the keys according to the instruction. As shown in FIG. 5, the user can press key “1”, “2”, “0”, and “0” in sequence according to the instruction to set the time to 12:00.

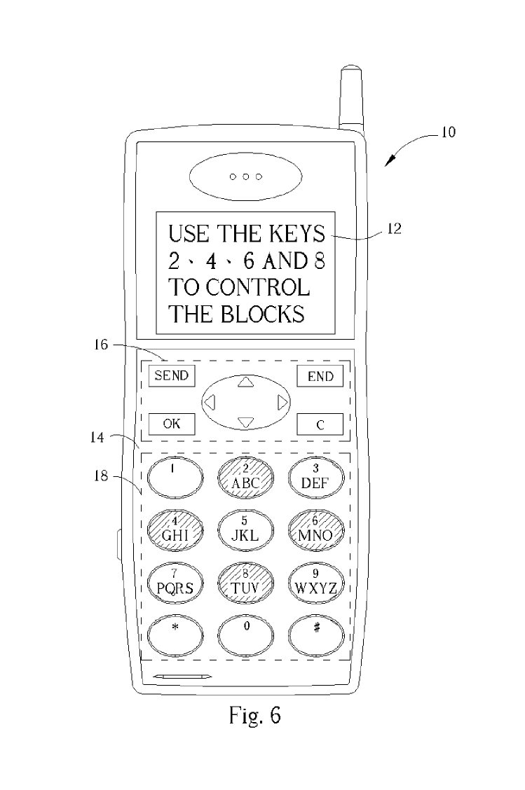

Please refer to FIG. 6 showing a “game” key instruction of the mobile phone 10. In general, the mobile phone 10 provides games for users to kill time. The basic operations of these games are commonly known but details may differ in some ways. While instructions of a game can be displayed on a prior art LCD panel 12, the present invention provides instructions on the LCD panel 12 as well as lighting up the corresponding keys. As shown in FIG. 6, after entering a game instruction, the LCD panel 12 displays the instruction to tell the user to press the keys “2”, “4”, “6”, and “8” for controlling the direction. Simultaneously the four keys “2”, “4”, “6”, and “8” are blinking. Moreover, when a game proceeds, the keys corresponding to the game will light up, so that even a beginner can play the game easily.

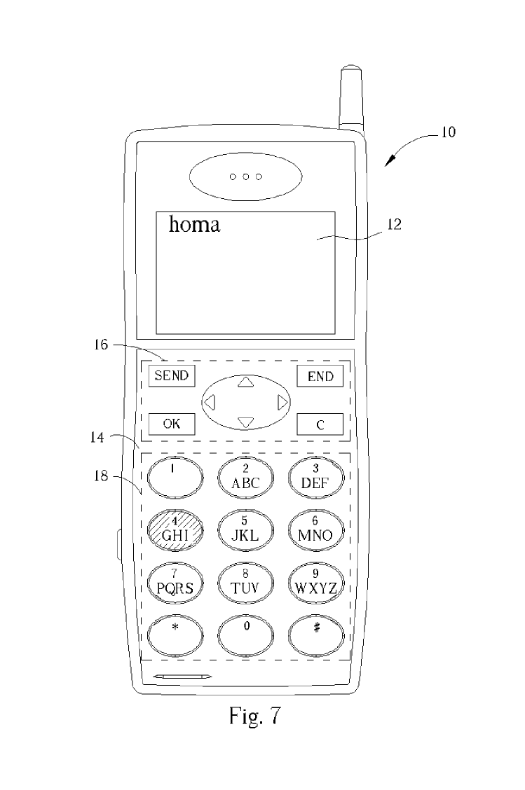

Please refer to FIG. 7 showing a data input help of the mobile phone 10. Although the number of the keys is limited and not very convenient for data input, the keys are often required to input data in different functions, such as a phonebook or message. Additionally, when using the mobile phone 10 to surf the Internet, the necessity of keypad input is paramount. The present invention can help the user to input data. For example, after inputting “hom”, the next letter can be “a” as in homage, “b” as in hombre, “e” as in home, “i” as in homicidal, “u” as in homunculus, or “y” as in homy, thus the keys “2”, “3”, “4”, “6”, “8”, and “9” can be selected. If all of the six keys blink, there are too many selections that are not helpful to the user. But after inputting “homa”, the selection will remain only “g”, i.e. key “4”, and the key “4” blinks. As shown in FIG. 7, the user can input “homage” according to the blinking keys. In case of data input, the corresponding keys blink to help the user. However, in order not to confuse the user, the corresponding key only blinks when one selection remains. Additionally, some data input are limited by conditions. For example, when inputting a date, the maximum is 31, thus when the user inputs a 3, only key “0” and “1” will blink.

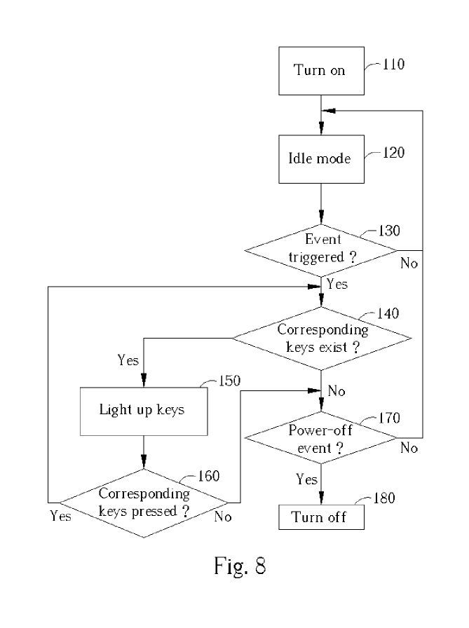

Please refer to FIG. 8 showing the flow of the present invention as follows:

Step 110: Turn on the mobile phone, and then the mobile phone accesses a service system;

Step 120: After accessing the service system, if no event is triggered, the mobile phone remains in idle mode;

Step 130: The mobile phone keeps on detecting events. When an event is triggered, proceed Step 140, if not, proceed Step 120;

Step 140: When the event is triggered, the mobile phone detects whether there are keys corresponding to the event. If yes, proceed Step 150, if not, proceed Step 170;

Step 150: If there are keys corresponding to the event, the mobile phone lights up the corresponding keys;

Step 160: The mobile phone detects whether the user presses the corresponding keys. If yes, proceed Step 140, if not, proceed Step 170;

Step 170: The mobile phone detects whether the user presses the power key. If yes, the event is a power-off event, proceed Step 180, if not, proceed Step 130;

Step 180: Turn off the mobile phone.

As described above, the present invention provides corresponding light sources for every key of the keypad 14. When any event is triggered, including internal events and external events such as receiving a call or the user pressing a key, the mobile phone 10 will detect whether there are corresponding keys, and light up or change the color or brightness of the corresponding keys. The present invention aids in preventing the user from being confused by the keys and allows a new user to get used to the mobile phone 10 quicker.

In contrast to the prior art, the present invention provides corresponding light sources for every key of the keypad that individually light up, change color, or change brightness to indicate which keys provide currently pertinent functions. Furthermore, the present invention additionally provides various functions such as key instruction, operation instruction, game key instruction, and data input help.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for controlling light sources of a keypad of a telephone, the telephone comprising a plurality of keys and a plurality of light sources installed correspondingly to the plurality of keys, and the method comprising:
detecting an operating status of the telephone; and
determining possibly enabled functions and changing at least one part of the light sources from a first status to a second status according to the possibly enabled functions, in order to show at least one key corresponding to the possibly enabled functions.

2. The method of claim 1 wherein the first status and the second status are different colors.

3. The method of claim 1 wherein the first status and the second status are different levels of brightness.

4. The method of claim 1 wherein the first status is no lighting and the second status is continuous lighting.

5. The method of claim 1 wherein the first status is no lighting and the second status is blinking.

6. The method of claim 1 wherein the first status is continuous lighting and the second status is no lighting.

7. The method of claim 1 wherein the first status is continuous lighting and the second status is blinking.

8. An electronic apparatus comprising:
a plurality of keys corresponding to at least one specific function respectively for inputting data;
a plurality of light sources installed correspondingly to the plurality of keys;
a status detecting device for detecting an operating status of the electronic apparatus; and
an controller for determining possibly enabled functions and changing the status of at least one part of the light sources according to the possibly enabled functions, in order to show at least one key corresponding to the possibly enabled functions.

9. The electronic apparatus of claim 8 wherein the controller makes the light source corresponding to at least one key corresponding to the possibly enabled functions in a blinking status.

10. The electronic apparatus of claim 8 wherein the controller makes the light source corresponding to at least one key corresponding to the possibly enabled functions in a continuous lighting status.

11. The electronic apparatus of claim 8 wherein each light source can generate light in different colors.

12. The electronic apparatus of claim 11 wherein the controller makes the light source corresponding to at least one key corresponding to the possibly enabled functions in a color changing status.

13. The electronic apparatus of claim 8 wherein each light source can generate light in different levels of brightness.

14. The electronic apparatus of claim 13 wherein the controller makes the light source corresponding to at least one key corresponding to the possibly enabled functions in a brightness level changing status.

15. The electronic apparatus of claim 8 being a telephone.

16. An electronic apparatus comprising:
a first key capable of enabling a first function of the electronic apparatus;
a second key capable of enabling a second function of the electronic apparatus;
a first light source installed near the first key for lighting up the first key;
a second light source installed near the second key for lighting up the second key;
a status detecting device for determining whether the first function or the second function can be enabled according to an operating status of the electronic apparatus; and
a controller for driving the first light source or the second light source according to an information provided by the status detecting device;
wherein when the status detecting device determines that the first function can be enabled and the second function is prevented to be enabled, the controller keeps light intensity of the second light source in a stable status and varies the light intensity of the first light source to identify the position of the first button.

17. The electronic apparatus of claim 16 being a telephone.

18. A method of controlling light sources of a keypad of a electronic device, the electronic device comprising:
a first key capable of enabling a first function of the electronic apparatus;
a second key capable of enabling a second function of the electronic apparatus;
a first light source installed near the first key for lighting up the first key;
a second light source installed near the second key for lighting up the second key,
the method comprising steps of:
determining whether one of the first function and the second function can be enabled according to an operating status of the electronic device; and
keeping light intensity of the second light source in a stable status and varying light intensity of the first light source to identify the position of the first button, when the first function can be enabled and the second function is prevented to be enabled under the operating status.
